(19) United States
(12) Patent Application Publication
(10) Pub. No.: US 2008/0183714 A1
(43) Pub. Date: Jul. 31, 2008

(54) LOCATION-BASED BROKERAGE SERVICE FOR HETEROGENEOUS ACCESS ROAMING

(75) Inventor: Madjid F. NAKHJIRI, Kirkland, WA (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/668,945

(22) Filed: Jan. 30, 2007

(51) Int. Cl. G06F 17/30

(52) U.S. Cl. 707/10

(57) ABSTRACT

A method, apparatus, and electronic device for managing heterogeneous network access requests are disclosed. A memory or database may store network access data for a mobile computing device to access a primary network. A network interface may receive via a foreign network a network access request from the mobile computing device and transmit an access permission to the mobile computing device via the foreign network.

### FIELD OF THE INVENTION

The present invention relates to a method and system for allowing a mobile computing device to access a foreign network. The present invention further relates to using an access broker to grant or deny a mobile computing device access to the foreign network.

### INTRODUCTION

A network may control access to that network by storing a set of information for each user in that network. When the user first joins the network, the user may be provided with a set of credentials identifying the user to that network. These credentials may then be matched with the network's own records on that user. These credentials and records are often referred to as authentication, authorization, and accounting (AAA). The credentials authenticate the user as being the same user recorded as a member of the network. The records indicate what level of access the user is authorized to have. The network may then, if appropriate, log the user's access and bill the user for usage.

Some network operators may also have an agreement with a separate network, or foreign network, to allow the user to access the foreign network under the home network's account. This roaming capability becomes essential as more and more users transition from fixed desktop computing devices to more mobile computing devices, resulting in access being required outside the home network. Currently, the foreign network refers access requests back to the home network in these roaming situations. These references can greatly reduce the speed and efficiency of the network. As access agreements become more complex, the access data becomes less scalable. Also, by allowing for these references to occur, the security of the network may become compromised due to spoofing and other identity theft techniques.

### SUMMARY OF THE INVENTION

A method, apparatus, and electronic device for managing heterogeneous network access requests are disclosed. A memory or database may store network access data for a mobile computing device to access a primary network. A network interface may receive via a foreign network a network access request from the mobile computing device and transmit an access permission to the mobile computing device via the foreign network.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a diagram one embodiment of a brokerage service network.

FIG. 2 illustrates in a diagram one embodiment of the authentication, authorization, and accounting broker executing an accounting service.

FIG. 3 illustrates in a flowchart one method for an authentication, authorization, and accounting broker between a primary network and a foreign network.

FIG. 4 illustrates in a flowchart one method for a primary network server to handle a new user entity location.

FIG. 5 illustrates in a flowchart one method for an authentication, authorization, and accounting broker to incorporate location data for the user entity.

FIG. 6 illustrates in a flowchart one method for an authentication, authorization, and accounting broker to proactively incorporate location data for the user entity.

FIG. 7 illustrates a possible configuration of a computer system to act as a mobile system or location server to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, network access broker, and access broker network for managing heterogeneous network access requests are disclosed. A memory or database may store network access data for a mobile computing device to access a primary network. A network interface may receive via a foreign network a network access request from the mobile computing device and transmit an access permission to the mobile computing device via the foreign network.

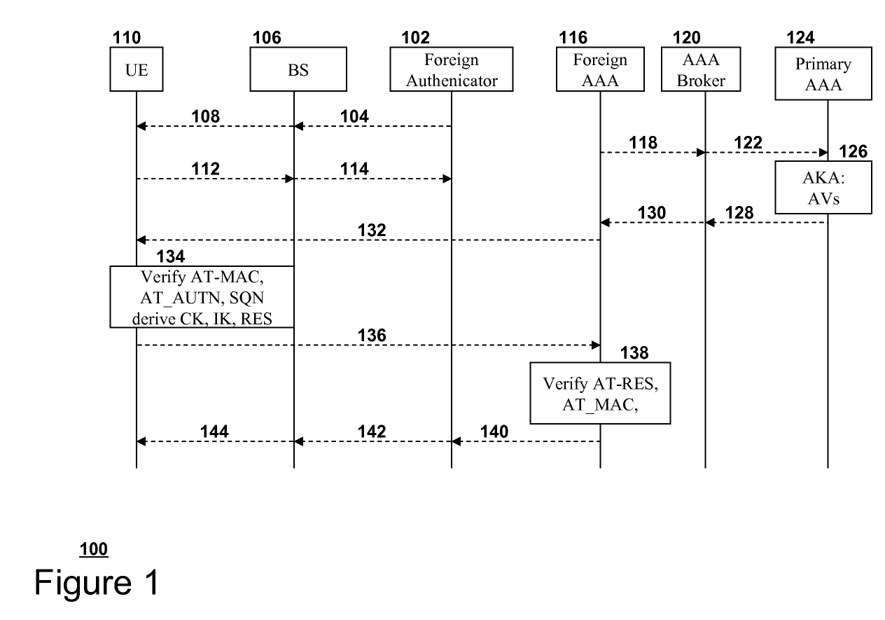

FIG. 1 illustrates in a diagram one embodiment of a brokerage service network 100. While the illustrated embodiment is of a system complying with Institute of Electrical and Electronic Engineers (IEEE) working group 802.16, also called a WiMax standard, the above brokerage service network 100 may be applied to any wireless network. An authenticator 102 for the foreign network transmits an identity request 104 to the base station 106 for that network. The identity request may follow the extensible authentication protocol (EAP), or any other suitable authentication protocol. The base station 106 may then send a new identity request 108 in a user accessible format to the user entity (UE) 110. The UE 110 may be any mobile computing device capable of accessing a wireless network. The user entity may be any mobile computing device that may access a network. The user accessible format may be privacy and key management, version 2 (PKMV2) or other formats. If the initial request 104 was in a user accessible format, the base station 106 may simply forward the request 104. The UE 110 may then provide a response 112 to the base station 106 confirming the identity of the UE 110. The base station 106 may send a response 114 with the necessary identity information to the foreign authenticator 102. Based on the identity response, the foreign network may be alerted as to which primary network needs to be accessed in order to achieve the proper authorization vectors.

Having determined the identity of the primary network of the UE, the foreign authentication, authorization, and accounting (AAA) server 116 may send a request 118 for the proper authorization vectors to the AAA broker 120. The AAA broker 120 would have previously sent a request 122 to the primary AAA server 124. The primary AAA server 124 may store all the necessary authentication vectors 126, according to the appropriate authentication and key agreements (AKA), for a UE belonging to that network. The primary AAA server 124 would have sent responses 128 to the AAA broker 120 containing the appropriate authentication vectors. The AAA broker 120 may generate responses 130 with these authentication vectors upon the request of the foreign AAA server 116. If no translation between servers is necessary, the responses 128 from the primary AAA server 124 may be simply forwarded to the foreign AAA server 116. These requests and responses may be formatted as remote authentication dial in user service (RADIUS) messages, the newer Diameter format, or some other format.

The foreign AAA server 116 may use the authentication vectors to send a further identity request 132 to the UE 110. If the request is formatted according to the EAP-AKA protocol, the request may contain the authentication vector, message authentication code (MAC) and other data, which is used by the subscriber identity module (SIM) of the UE 110 to calculate 134 a confidentiality key, an integrity key, and a result. The UE 110 incorporates the result and message authentication code into a response 136, which is forwarded to the foreign AAA server 116. The foreign AAA server 116 uses this information to verify 138 the UE 110. The foreign AAA server 116 sends a notice of success 140 to the foreign authenticator 102. The foreign authenticator 102 in turn sends a notice of success 142 to the base station 106, which sends a notice of success 144 to the UE 110. If no translation is needed, the same message may be forwarded throughout.

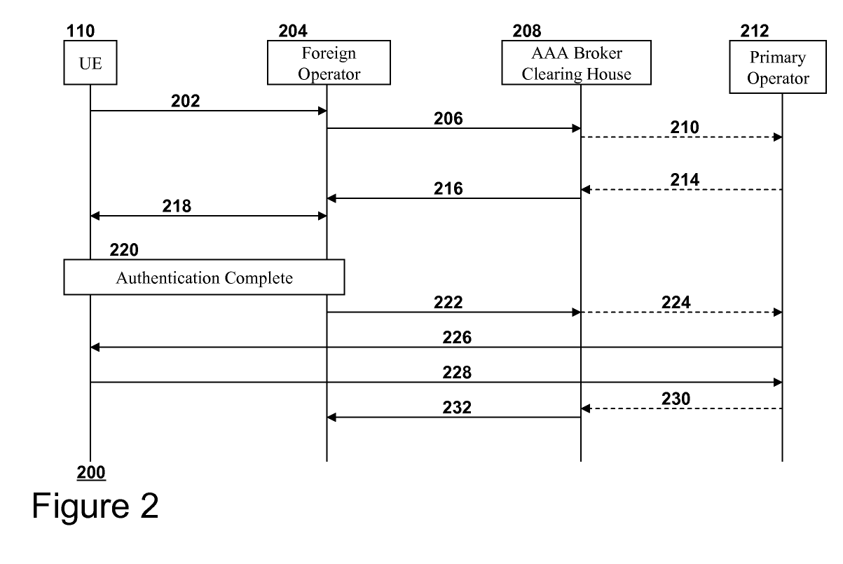

FIG. 2 illustrates one embodiment of the AAA broker executing an accounting service. The UE 110 may send an access request 202 to the foreign network operator 204, which sends an authorization vector request 206 to the AAA broker clearing house 208. The AAA broker clearing house 208 will have previously sent an authorization vector request 210 to the primary network operator 212, and received a response 214 with the authorization vectors. The AAA broker clearing house 208 will send a response 216 to the foreign network operator 204. The foreign network operator 204 may perform an authentication transaction 218 with the UE 110. Once an authenticated connection 220 is established, the foreign network operator 204 may transmit accounting records 222 of the connection 220 to the AAA broker clearing house 208. The AAA broker clearing house 208 forwards billing records 224 on to the primary network operator 212 based on the operator-broker agreement. The primary network operator 212 sends a bill 226 to the UE 110, who remits payment 228, or disputes payment if fraud has occurred. The primary network operator 212 forwards the appropriate payment percentage 230 to the AAA broker clearing house 208. The AAA broker clearing house 208 forwards to the foreign network operator 204 its cut 232 of the payment.

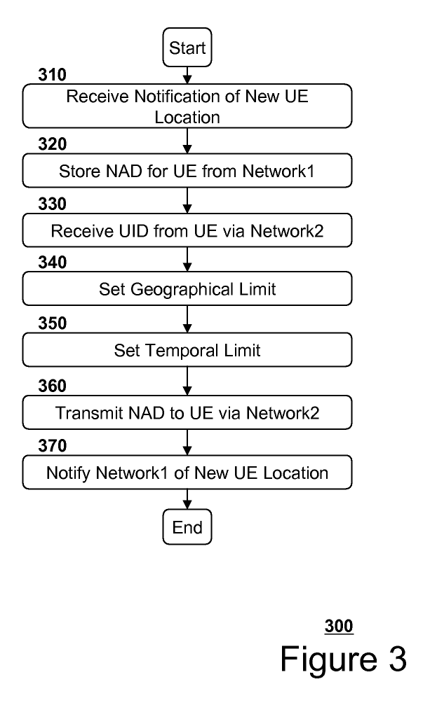

FIG. 3 illustrates in a flowchart one method 300 for an AAA broker 120 between a primary network and a foreign network. The AAA broker 120 receives notification of a new UE location (Block 310). The notification of this temporary location change may come from the user or from some other source. The notification may include a duration and a new location, or simply a notification that the UE will spend a period of time away from the primary network (Network1). The AAA broker 120 may store network access data (NAD), such as a set of authorization vectors, for the UE 110 from the primary network (Block 320). The AAA broker 120 may receive a user identifier (UID) from the UE 110 via the foreign network (Network2) (Block 330). The UID may be a key or a response to a network identity request that identifies the user to the network so that the network may confirm whether the UE has access permission for the network. The AAA broker 120 may set a geographical limit, limiting access permission only to networks in a specific geographical area (Block 340). The AAA broker 120 may also set a temporal limit, making access permission only available for a set period of time (Block 350). The AAA broker 120 may transmit the NAD to the UE 110 via the foreign network (Block 360). The AAA broker 120 may then notify the primary network of the new location for the UE 110 (Block 370).

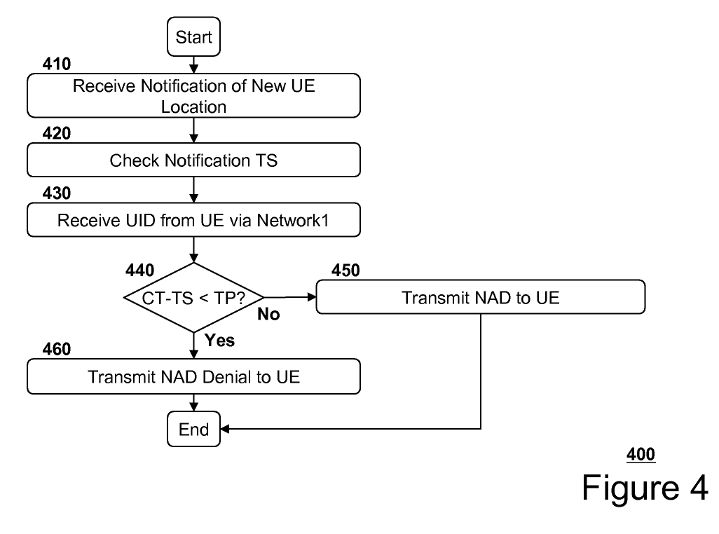

FIG. 4 illustrates in a flowchart one method 400 for a primary network server to handle a new location data for a UE. The primary network server receives notification of a new UE location (Block 410). The primary network server may check the timestamp (TS) on the notification, indicating when the notification was sent (Block 420). The primary network server may receive a UID from a device claiming to be the UE 110 via the primary network (Block 430). If the time elapsed since the transmission of the notification (current time (CT)—TS) is not within a preset time period (TP) (Block 440), the UE is assumed to have returned to its primary network and the primary network server transmits a NAD to the UE (13lock 450). Otherwise, the primary network transmits a NAD denial to the device claiming to be the UE 110.

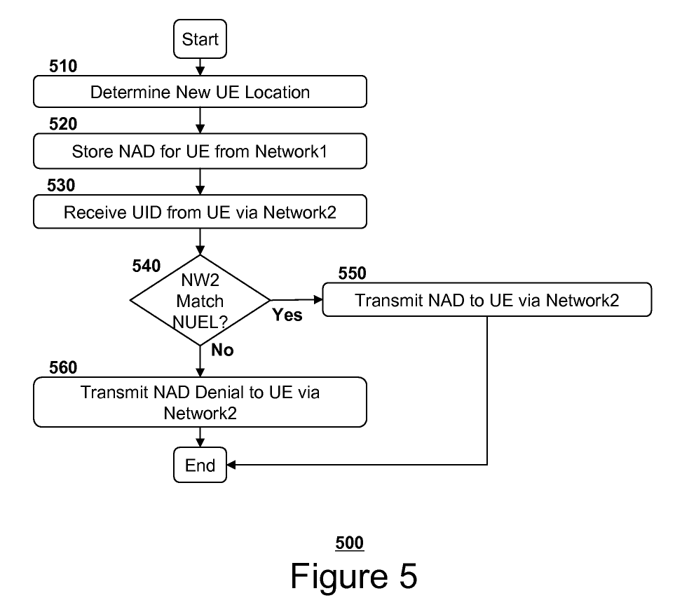

FIG. 5 illustrates in a flowchart one method 500 for an AAA broker 120 to incorporate location data for the UE 110. The AAA broker 120 may determine a new UE location (Block 510). The AAA broker 120 may accomplish this through a global positioning device incorporated into the UE device, or through other methods known in the art. The AAA broker 120 may store NAD for the UE from the primary network (Block 520). The AAA broker 120 may receive a UID from a device claiming to be the UE via the foreign network. If the foreign network (NW2) does not match the new UE location (NUEL) (Block 540), then the AAA broker 120 transmits the NAD to the UE via the foreign network (Block 550). Otherwise, the AAA broker 120 transmits a NAD denial to the device claiming to be the UE via the foreign network (Block 560).

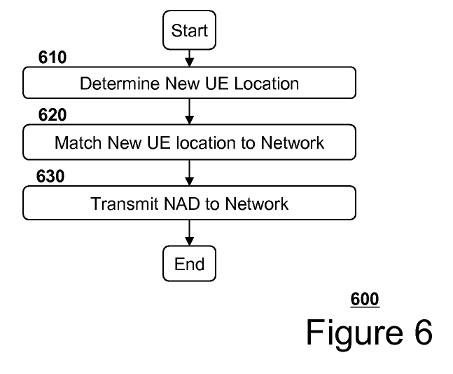

FIG. 6 illustrates in a flowchart one method 600 for an AAA broker 120 to proactively incorporate location data for the UE 110. The AAA broker 120 may determine a new UE location (Block 610). The new UE location may be determined using a sensor network, such as a global positioning system (GPS) network. The AAA broker 120 may match the new UE location to a network (Block 620). The AAA broker 120 may then transmit the NAD to the chosen network prior to receiving any UID (Block 630).

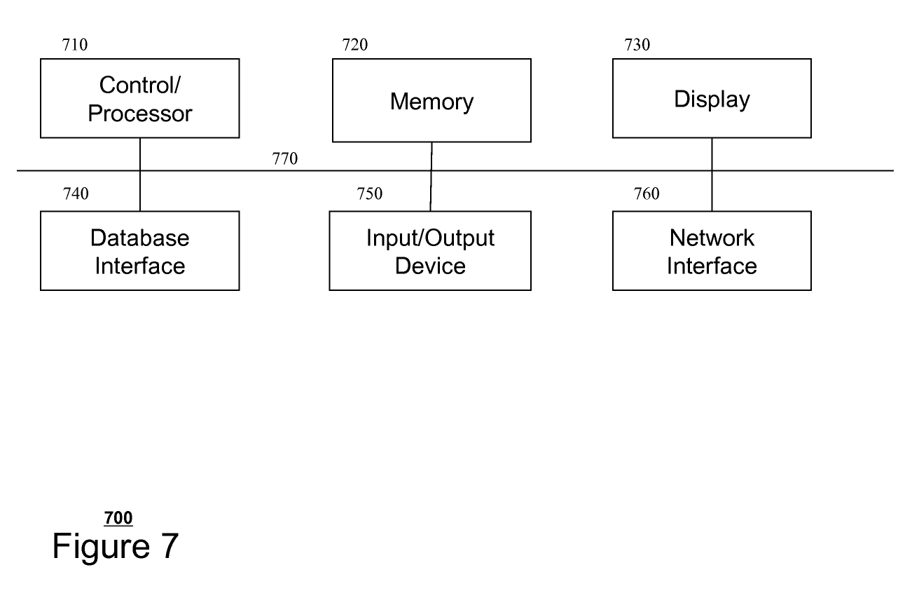

FIG. 7 illustrates a possible configuration of a computing system 700 to act as a mobile system, network server, or AAA broker to execute the present invention. The computer system 700 may include a controller/processor 710, a memory 720, display 730, input/output device interface 740, a receiver 750, and a transmitter 760, connected through bus 770. The computer system 700 may implement any operating system, such as Windows or UNIX, for example. Client and server software may be written in any programming language, such as ABAP, C, C++, Java or Visual Basic, for example.

The controller/processor 710 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 720 may include volatile and nonvolatile data storage, including one or more electrical, magnetic or optical memories such as a RAM, cache, hard drive, CD-ROM drive, tape drive or removable storage disk. The memory may have a cache to speed access to specific data.

The Input/Output interface 750 may be connected to one or more input devices that may include a keyboard, mouse, pen-operated touch screen or monitor, voice-recognition device, or any other device that accepts input. The Input/Output interface 750 may also be connected to one or more output devices, such as a monitor, printer, disk drive, speakers, or any other device provided to output data.

The network interface 760 may be connected to a communication device, modem, network interface card, a transceiver, or any other device capable of transmitting and receiving signals over a network. The components of the computer system 700 may be connected via an electrical bus 770, for example, or linked wirelessly.

Client software and databases may be accessed by the controller/processor 710 from memory 720 or through the database interface 740, and may include, for example, database applications, word processing applications, the client side of a client/server application such as a billing system, as well as components that embody the decision support functionality of the present invention. The user access data may be stored in either a database accessible through the database interface 740 or in the memory 720. The computer system 700 may implement any operating system, such as Windows or UNIX, for example. Client and server software may be written in any programming language, such as ABAP, C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for managing heterogeneous network access requests, comprising:
storing network access data for a mobile computing device to access a primary network;
receiving from a foreign network a user identifier for the mobile computing device;
transmitting network access data to the foreign network to confirm access permission for the mobile computing device.

2. The method of claim 1, further comprising limiting the access permission to a geographical area.

3. The method of claim 1, further comprising limiting the access permission to a time period.

4. The method of claim 1, further comprising transmitting new location data for the mobile computing device to the primary network.

5. The method of claim 4, wherein the primary network denies access based on the new location data.

6. The method of claim 1, further comprising receiving a notification of a temporary location change for the mobile computing device.

7. The method of claim 1, further comprising determining a location of the mobile computing device.

8. The method of claim 7, further comprising providing the access permission based on the location.

9. The method of claim 7, further comprising transmitting the network access data to the foreign network prior to the network access request based on the location.

10. A network access broker, comprising:
a memory that stores network access data for a mobile computing device to access a primary network;
a network interface that receives from a foreign network a user identifier for the mobile computing device and transmits network access data to the foreign network to confirm access permission for the mobile computing device.

11. The network access broker of claim 10, wherein the access permission is limited to a geographical area.

12. The network access broker of claim 10, wherein the access permission is limited to a time period.

13. The network access broker of claim 10, wherein the network interface transmits new location data for the mobile computing device to the primary network.

14. The network access broker of claim 10, wherein the network interface receives a notification of a temporary location change for the mobile computing device.

15. The network access broker of claim 10, wherein the network interface receives from a sensor network determines a location of the mobile computing device.

16. The network access broker of claim 15, wherein the access permission is based on the location.

17. The network access broker of claim 15, wherein the network interface transmits the network access data to the foreign network prior to the network access request based on the location.

18. An access broker network, comprising:
a server that stores network access data for a mobile computing device to access a primary network, from a foreign network a user identifier for the mobile computing device and transmits network access data to the foreign network to confirm access permission for the mobile computing device.

19. The access broker network of claim 18, further comprising a sensor network determines a location of the mobile computing device.

20. The access broker network of claim 19, wherein the network interface transmits the network access data to the foreign network prior to the network access request based on the location.
